(19) United States
(12) Patent Application Publication
(10) Pub. No.: US 2012/0270944 A1
(43) Pub. Date: Oct. 25, 2012

(54) ANTIOXIDANTS AND VEGETABLE OILS AS STABILIZERS OF INSECT SEMIOCHEMICALS

(75) Inventors: Qing-He Zhang, Spokane Valley, WA (US); Rodney G. Schneidmiller, Greenacres, WA (US)

(73) Assignee: STERLING INTERNATIONAL INC., Spokane, WA (US)

(21) Appl. No.: 13/457,149

(22) Filed: Apr. 26, 2012

Related U.S. Application Data
(63) Continuation of application No. 13/452,744, filed on Apr. 20, 2012.
(60) Provisional application No. 61/477,521, filed on Apr. 20, 2011.
(60) Provisional application No. 61/622,863, filed on Apr. 11, 2012.
(60) Provisional application No. 61/482,023, filed on May 3, 2011.

(51) Int. Cl. A01N 27/00; A01N 37/06

(52) U.S. Cl. 514/549; 514/762

(57) ABSTRACT

Semiochemicals are combined with oils and/or antioxidants in order to control and maintain the necessary threshold release rates of the semiochemicals (such as attractants or repellents) from release devices for optimal activity/performance, for the reduction or elimination of semiochemical oxidation, isomerization, breakdown and polymerization, and also for stabilizing and/or protecting the active semiochemical ingredients.

### CROSS-REFERENCES TO RELATED APPLICATIONS

This application is a continuation-in-part of U.S. patent application Ser. No. 13/452,744, filed Apr. 20, 2012, which claims the benefit of U.S. Provisional Application No. 61/477,521, filed Apr. 20, 2011, and this application claims the benefit of U.S. Provisional Application No. 61/622,863, filed Apr. 11, 2012, and U.S. Provisional Application No. 61/482,023, filed May 3, 2011, the disclosures of which are hereby incorporated herein expressly by reference.

### BACKGROUND

Insect semiochemicals are chemicals emitted by a plant or animal that evoke behavioral or physiological responses in another organism. A semiochemical that affects an individual of the same species is called a pheromone. A semiochemical that affects individuals of a different species are called allelochemicals. Allelochemicals include kairomones, allomones and synomones. Kairomones are emitted by an individual of one species that benefits another species without providing a benefit to the emitting species, while allomones are emitted by an inidvidual of one species that harms another species and benefits the emitting species. Synomones, on the other hand, operate between species and benefit both the emitter and the receiver.

A use of insect pheromones, and other semiochemicals, is to lure insects to traps for detection and monitoring of pest insect populations or for mass-trapping to reduce their populations. Traps may be designed to make escaping from the trap difficult. Once inside the trap, the insect will desiccate or drown in water within the trap. Semiochemicals can also be used as a broadcast signal to disrupt insect mating (so-called mating disruption), to repel or interrupt insect behaviors as repellents or attraction-inhibitors. Semiochemical-baited traps or dispensers offer a safer alternative to the use of toxic pesticides, especially for use in and around residential areas and food crops.

There are thousands of known semiochemicals (see, for example, http://www.pherobase.com). Research into finding semiochemicals that may provide a benefit is an ongoing endeavor. Disclosed herein are means to prolong the efficacy of semiochemicals.

### SUMMARY

Most semiochemicals are volatile compounds, and it has been found that in neat forms or high concentrations, many semiochemicals are easily oxidized, isomerized, broken-down or polymerized when exposed to the oxygen in the atmosphere or to the light.

Such chemical reactions would significantly decrease the release rate of semiochemicals from their dispensers and also affect the durability of the synthetic or natural semiochemicals. Ultimately, the semiochemicals may lose their behavioral activity (operational performance). Disclosed herein are additive or preservative compositions that may avoid such detrimental consequences for semiochemicals. Such compositions are useful in controlling insect behaviors.

Accordingly, a method for controlling insect behavior is disclosed. The method includes placing into a release device configured to achieve a desired rate of release of semiochemical volatiles, a composition comprising an antioxidant and/or an insect-inactive oil; and a semiochemical; releasing semiochemical volatiles into an area, wherein the release rate of the semiochemical volatiles is controlled through the device, or the presence of the antioxidant or insect-inactive oil in the composition; and controlling the behavior of an insect within the area with the semiochemical volatiles.

The semiochemical may be a pheromone, an allomone, a kairomone, or a synomone.

The insect-inactive oil may be derived from a plant.

The insect-inactive oil may be a liquid.

The insect-inactive oil may be a vegetable oil.

The insect-inactive oil may be a nut oil.

The composition may include more than one semiochemical.

The composition may include more than one oil.

The composition may include more than one antioxidant.

The antioxidant may be α-tocopherol, propyl gallate, tertiary butylhydroquinone, butylated hydroxytoluene, or butylated hydroxyanisole.

The semiochemical may be released through one or more apertures in the release device.

The device may include a polymeric sheet comprising a plurality of laminae. An innermost lamina of the plurality of laminae may be semi-permeable such that the semiochemical in a volatilized state can pass through the innermost lamina.

The polymeric sheet may include an innermost lamina that is permeable to the semiochemical vapors and an outer lamina that is configured to peal away from the inner lamina.

The composition may be a liquid.

The disclosed additive or preservative compositions may also provide vaporization control and maintain the necessary threshold release rates of semiochemicals (such as attractants or repellents) from release devices for optimal activity and/or performance.

The disclosed additive or preservative compositions may provide for the reduction or elimination of semiochemical oxidation, isomerization, breakdown and polymerization.

The disclosed additive or preservative compositions may stabilize and/or protect the active semiochemical ingredients.

The disclosed additive or preservative compositions may be used in insect control devices. As used herein, “insect control” includes any activity affecting an insect, including, but not limited to, attracting, repelling, killing, trapping or otherwise affecting insect behavior.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows a front view of a first embodiment of a semiochemical stick pack;

FIG. 1B shows a side view of the semiochemical stick pack shown in FIG. 1A;

FIG. 1C shows an end view of the semiochemical stick pack shown in FIG. 1A;

FIG. 2A shows schematically a cross section of the semiochemical stick pack through section 2-2 in FIG. 1A, showing a solid particulate semiochemical composition therein;

FIG. 2B shows schematically a cross section of the semiochemical stick pack through section 2-2 in FIG. 1A, showing a liquid semiochemical composition therein;

FIG. 3 shows a fragmentary cross-sectional view of a sheet material for semiochemical stick packs in accordance with the present invention, wherein the various dimensions are exaggerated to illustrate aspects of the sheet material;

FIG. 4 shows schematically a system diagram for an apparatus for producing stick packs packaged with a semiochemical;

FIG. 5 is a flow diagram illustrating an exemplary method for controlling the rate of release of volatiles of semiochemicals;

FIG. 6 illustrates another embodiment of a multi-compartment semiochemical stick pack;

FIG. 7 illustrates another embodiment of a semiochemical stick pack, having a window portion for the controlled release of volatiles;

FIGS. 8A and 8B illustrate a panel for forming another embodiment of a semiochemical stick pack, wherein FIG. 8B is a sectional view through section 8B-8B in FIG. 8A;

FIG. 9 is a front view of the stick pack formed from the panel shown in FIGS. 8A and 8B; and

FIGS. 10A and 10B show alternative designs for a stick pack similar to the stick pack shown in FIG. 9, with different window configurations.

### DETAILED DESCRIPTION

Disclosed herein are compositions and methods for the reduction or elimination of semiochemical oxidation, isomerization, breakdown and polymerization, and also for stabilizing and/or protecting the active semiochemical ingredients, and for controlling the release rate of semiochemicals.

In one embodiment, a composition includes one or more antioxidants combined with any semiochemical.

In one embodiment, a composition includes one or more “insect-inactive” oils combined with any semiochemical. “Insect-inactive” oil means the oils disclosed herein as additives for semiochemicals, and is meant to distinguish from “insect-active” oils, such as the essential oils, which have been shown to be effective at repelling insects. It is possible however, that the insect-inactive oils can be combined with the insect-active essential oils to achieve the benefits discussed above.

In one embodiment, the disclosed composition includes one or more insect-inactive oils and one or more antioxidants combined with any semiochemical.

Suitable antioxidants for use with semiochemicals include, but are not limited to tocopherols, α-tocopherol, ascorbic acid, as well as synthetic antioxidants such as propyl gallate, tertiary butylhydroquinone, butylated hydroxytoluene (BHT), and butylated hydroxyanisole (BHA). BHT or BHA, among other similar antioxidant compounds, are soluble in most of the insect semiochemicals, especially pheromones; and can react efficiently with oxygen in the semiochemical dispensing systems to avoid oxidation, isomerization, breakdown and polymerization of the semiochemicals. One class of antioxidants are lipophilic (fat-soluble) organic compounds that are primarily used as antioxidant food additives.

Suitable antioxidants also include polar antioxidants, such as phenolic alcohols, flavonoids, catechins, anthocyanins, and their glycosides. The polar phenolics are advantageous for stabilization of the polar semiochemicals.

While representative oxidants have been listed for purposes of illustrating embodiments of the invention, it is to be appreciated that other antioxidants not specifically listed above, may also be used.

Suitable insect-inactive oils to use with semiochemicals include, but are not limited to oils derived from plants, such as vegetable oils and nut oils. These are widely available and cost effective. Suitable oils include, but are not limited to, canola oil, cottonseed oil, palm oil, safflower oil, soybean oil, corn oil, olive oil, peanut oil, sunflower oil, sesame oil, and coconut oil, among many others. Nut oils include, but are not limited to, almond oil, cashew oil, hazelnut oil, macadamia oil, mongongo nut oil, pecan oil, pine nut oil, pistachio oil, sacha inchi oil, walnut oil plus many others. Melon gourd seed oils are very common and inexpensive. The oils listed above include saturated, monounsaturated, and polyunsaturated fatty acids; which are soluble in many insect semiochemicals, especially the less- or non-polar ones.

While representative oils have been listed for purposes of illustrating embodiments of the invention, it is to be appreciated that other oils not specifically listed above may also be used.

Semiochemicals that may be combined with one or more insect-inactive oils, one or more antioxidants, or both, include but are not limited to, pheromones, kairomones, allomones, and synomones (such as herbivore-induced plant volatiles (HIPVs)). However, the listing of semiochemicals is not limited to the use of any class or specific semiochemicals, as the oils and antioxidants can be combined with any one or more of the known semiochemicals for stabilizing the semiochemical against oxidation, and/or for controlling the release rate of the semiochemical from a release device. The listing of semiochemicals below is meant to be illustrative only.

As used herein, a semiochemical is defined to include any chemical that operates to modify or affect the behavior of an insect. For example, repellant-type semiochemicals may be used to drive certain insects out of an area or to prevent or reduce insect ingress into an area, such as a building, or to repel particular insects from an individual or animal.

It is believed that all or most insects use semiochemicals that affect the behaviors of other individuals. Pheromones provide intra-species signals that aid in finding mates, food and habitat resources, warning of enemies, and avoiding competition. Allomones and kairomones provide interspecies signals that provide similar functions. The goals of using semiochemicals in insect management are typically to monitor populations, and/or to alter insect behavior. Semiochemicals generally have the benefits of being highly targeted, relatively nontoxic, nonpersistent and environmentally safe, and difficult for insects to develop resistance against.

Pheromones may be classified by behavioral function, and include such pheromones as aggregation pheromones, alarm pheromones, sex pheromones, marking pheromones, and trail pheromones.

Semiochemicals that may be prone to degradation, oxidation, isomerization, breakdown, or polymerization may include, methyl(E,E,Z)-2,4,6-decatrienoate and methyl(E,Z)-2,4-dodecadienoate, their isomers and analogs, or any combination thereof.

However, it is possible that other semiochemicals may be degraded, isomerized, or polymerized to some extent. Accordingly, it is possible that any semiochemical may benefit by combining with an antioxidant and/or insect-inactive oil.

Additional suitable semiochemicals include, but are not limited to the compounds recited in U.S. Pat. No. 5,707,638, which is fully incorporated herein by reference. A more updated and completed list of the known semiochemicals can be found at the Pheromone database (http://www.pherobase.com). Suitable compounds may include, Z-5-decenyl acetate, dodecanyl acetate, Z-7-dodecenyl acetate, E-7-dodecenyl acetate, Z-8-dodecenyl acetate, E-8-dodecenyl acetate, Z-9-dodecenyl acetate, E-9-dodecenylacetate, E-10-dodecenyl acetate, 11-dodecenyl acetate, Z-9,11-dodecadienyl acetate, E-9,11-dodecadienyl acetate, Z-11-tridecenyl acetate, E-1-tridecenyl acetate, tetradecenyl acetate, E-7-tetradecenyl acetate, Z-8-tetradecenyl acetate, E-8-tetradecenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tridecadienyl acetate, 4-methoxy-cinnamaldehyde, β-ionone, estragole, eugenol, indole, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7,11-hexadecadienyl acetate, Z,E-3,13-octadecadienyl acetate, E,Z-3,13-octadecadienyl acetate, E,E-3,13-octadecadienyl acetate, ethanol, hexanol, heptanol, octanol, decanol, Z-6-nonenol, E-6-nonenol, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,10-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9,11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, E-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9,11-hexadecadienal, E,E-10,12-hexadecadienal, E,Z-10,12-hexadecadienal, Z,E-10,12-hexadecadienal, Z,Z-10,12-hexadecadienal, Z,Z-11,13-hexadecadienal, octadecanal, Z-11-octadecenal, E-13-octadecenal, Z-13-octadecenal, Z-5-decenyl-3-methyl-butanoate, Disparlure: (+) cis-7,8-epoxy-2-methyloctadecane, Seudenol: 3-methyl-2-cyclohexen-1-ol, sulcatol: 6-methyl-5-hepten-2-ol, Ipsenol: 2-methyl-6-methylene-7-octen-4-ol, Ipsdienol: 2-methyl-6-methylene-2,7-octadien-4-ol, Grandlure I: cis-2-isopropenyl-1-methyl-cyclobutanethanol, Grandlure II: Z-3,3-dimethyl-1-cyclohexanethanol, Grandlure III: Z-3,3-dimethyl-1-cyclohexaneacetaldehyde, Grandlure IV: E-3,3-dimethyl-1-cyclohexaneacetaldehyde, cis-2-verbenol: cis-4,6,6-trimethylbicyclo[3,1,1]hept-3-en-2-ol cucurbitacin, 2-methyl-3-buten-2-ol, 4-methyl-3-heptanol, cucurbitacin, 2-methyl-3-buten-2-ol, 4-methyl-3-heptanol, α-pinene: 2,6,6-trimethylbicyclo[3,1,1]hept-2-ene, α-caryophyllene: 4,11,11-trimethyl-8-methylenebicyclo[7,2,0]undecane, Z-9-tricosene, α-multistriatin 2(2-endo, 4-endo)-5-ethyl-2,4-dimethyl-6,8-dioxabicyclo[3,2,1]octane, methyleugenol: 1,2-dimethoxy-4-(2-propenyl)phenol, Lineatin: 3,3,7-trimethyl-2,9-dioxatricyclo[3,3,1,0]nonane, Chalcogran: 2-ethyl-1,6-dioxaspiro[4,4]nonane, Frontalin: 1,5-Dimethyl-6,8-dioxabicyclo[3,2,1]octane, endo-Brevicomin: endo-7-ethyl-5-methyl-6,8-dioxabicyclo[3,2,1]octan, exo-brevicomin-exo-7-ethyl-5-methyl-6,8-dioxabicyclo[3,2,1]octane, (Z)-5-(1-decenyl)dihydro-2-(3H)-furanone, Farnesol 3,7-11-trimethyl-2,6,10-dodecatrien-1-ol, Nerolidol 3,7-,11-trimethyl-1,6,10-dodecatrien-3-ol, 3-methyl, 6-(1-methyl ethenyl)-9-decen-1-ol acetate, (Z)-3-methyl-6-(1-methylethenyl)-3,9-decadien-1-ol acetate, (E)-3,9-methyl-6-(1-methylethenyl)-5,8-decadien-1-ol-acetate, 3-methylene-7-methyl-octen-1-ol propionate, (Z)-3,7-dimethyl-2,7-octadien-1-ol propionate, (Z)-3,9-dimethyl-6-(1-methylethenyl)-3,9-decadien-1-ol propionate, the Harlequin bug pheromone, murgantiol, the Gypsy moth sex pheromone, disparlure, 2-methyl-7R,8S-epoxy-octadecane, the Japanese beetle sex pheromone, (R)-japonilure, (R,Z)-5-(−)-(1-decenyl)oxacyclopentan-2-one, other unsaturated or branched long-chain hydrocarbons as type II insect pheromones, and any combination thereof.

Suitable allomones include but are not limited to 2-allyl-4,5-dimethoxyphenol, (Z)-9-tetradecenal, (Z)-9-tetradecenyl acetate, (Z,E)-9,12-tetradecadienyl acetate, (Z)-11-hexadecenal, [(6-O-hexopyranosylhexopyranosyl)-oxy](phenyl)-acetonitrile, or any combination thereof.

Suitable synomones (e.g. HIPVs) may include but are not limited to (E)-4,8-dimethyl-1,3,7-nonatriene, (Z)-4,8-dimethyl-1,3,7-nonatriene, 4,8,12-trimethyl-1,3E,7E,11-tridecatetraene, or any analogs thereof, trans-β-ocimene, cis-β-ocimene, trans-α-ocimene, cis-α-ocimene, or any analogs thereof, and any combination thereof.

Additional HIPVs and pheromones are described in U.S. Pat. No. 6,528,049, which is incorporated herein by reference.

Representative attractant compounds are described in U.S. Pat. No. 6,740,319, which is incorporated herein by reference. The attractant compounds include (E)-2-hexenal, α-terpineol, (E)-2-hexenal, linalool, acetic acid, isobutanol, racemic 2-methyl-1-butanol, S-(−)-2-methyl-1-butanol, 2-methyl-2-propanol, heptyl butyrate and butyl butyrate.

Representative repellents may include any of the following essential oils (the insect-active oils) or their constituents. The essential oils are: anise oil, castor oil, cedar oil, cinnamon oil, citronella oil, clove oil, corn oil, cottonseed oil, fennel seed oil, garlic oil, geranium oil, lavender oil, lemongrass oil, linseed oil, mint oil, patchouli oil, pennyroyal oil, peppermint oil, Roman chamomile oil, rosemary oil, sage oil, sesame oil, soybean oil, spearmint oil, thyme oil, wintergreen oil, and ylang ylang oil, or any combination thereof. The constituents include: I-menthone, P-menthone, eugenol, E-citral, Z-citral, pulegone, α-thujone, β-thujone, methyl benzoate, l-carvone, methyl salicylate, E/Z-nepetalactone, Z/E-nepetalactone, 3-octanol, benzyl acetate, and citronellal, or any combination thereof.

Representative insect attractants may include acetic acid; short chain alcohols chosen from 2-methyl-1-butanol, isobutanol, and 2-methyl-2-propanol, or a combination thereof; homo- or mono-terpene herbivore-induced plant (HIPVs) volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof.

The representative compounds listed above that may be combined with one or more insect-inactive oils, and one or more antioxidants, or both, is not meant to be exhaustive, since any known semiochemical that may be oxidized by contact with air or which may be dispensed may be combined with one or more insect-inactive oils, one or more antioxidants, or one or more of both. Furthermore, combinations of one or more semiochemicals may also be used.

One insect control technology is the use of semiochemicals to attract or lure an insect to a trap compartment from which the insect can not escape. In such traps, the insect will die from dehydration or the insect may drown if the compartment is filled with a liquid. The semiochemical may be provided as a solid or liquid composition within the trap compartment. Alternatively, the semiochemical composition may be applied to an absorbent substrate. In one embodiment, the semiochemical composition is in a powder or particulate form. However, in other embodiments, the semiochemical composition may be in liquid form, or incorporated into a gel, paste, or solid matrix, or absorbed onto a porous medium such as a sponge or paper, for example.

When the semiochemical is combined with one or more insect-inactive oils, the semiochemical exhibits a slower release rate. Due to the non (and low) volatility properties of the oils. Oils such as cooking oils (especially vegetable oils) can be used to dilute the semiochemicals for controlling the release rate from various devices used in traps. When the semiochemical is combined with one or more antioxidants, it is believed that the antioxidants react with free radicals and oxygen, thus, the antioxidant avoids or prolongs, to some extent, oxidation, breakdown and polymerization of the semiochemical. Thus, the useful life of the semiochemical in the trap can be extended.

Suitable insect traps that may include the use of the compositions described herein are, for illustration purposes only, disclosed in U.S. Pat. Nos. 7,886,481; and 6,910,298, fully incorporated herein expressly by reference.

The choice of antioxidant and/or insect-inactive oil will be dependent on the chemical properties of the semiochemical. For example, whether the semiochemical is polar, non polar, or only slightly polar, whether the semiochemical is easily volatized or whether the semiochemical volatizes slowly, are factors that will determine which insect-inactive oil and/or antioxidant to use. It should be appreciated that more than one semiochemical can be used in the semiochemical compositions disclosed herein, since some semiochemical combinations provide a synergistic effect. The trap design may also dictate whether the semiochemical composition is provided as a solid or liquid. When provided as a liquid, it is not necessary that the semiochemical be soluble in the oil or antioxidant, as the semiochemical can be emulsified in the oil or antioxidant. In some embodiments, regardless of whether the semiochemical is dissolved or emulsified in the oil or antioxidant, the solution or emulsion will be applied onto a solid substrate. A method of applying the insect-inactive oil, antioxidant and the semiochemical on substrates may include, spraying the substrate, or dipping the substrate into the semiochemical compositions. The amount of antioxidant or oil, or both may vary based on the intended semiochemical.

The weight percents of the constituents of the compositions disclosed herein may vary. Any insect-inactive oil, antioxidant, and semiochemical may comprise about, at most about, or at least about a weight percent of 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.6, 97, 97.5, 98, 98.5, 99, or 99.5% or more, but less than 100%, of a composition, or any range derivable therein.

Any composition embodiment herein may comprise, consist essentially of, or consist of components, ingredients, steps, etc. With respect to “consist essentially of,” such embodiments are drawn to the specified components, ingredients, steps, etc., and those that do not materially affect the basic and novel characteristics of the composition. Non-limiting examples of those components that do not materially affect the basic and novel characteristics may include propellants, such as nitrogen, if the composition is provided as a spray. With respect to “consist of,” such embodiments are drawn to the specified components only.

The dispensing of antioxidants, and/or insect-inactive oils with semiochemicals may be by way of passive evaporation or volatilization from a device or a propelled release method, such as dispersion by an aerosol spray.

There can also be provided a controlled release device that is used to control the release rate of volatilization. A release device can be a container having a space therein to house a material onto which one or more of the semiochemicals with the antioxidants and/or the insect-inactive oils is impregnated. Suitable materials can be fibrous, porous, solids, or flexible materials. Suitable materials may include such absorbent materials such as paper, porous plastics, absorbent minerals, carbon, and the like. The release device can have an opening on the outer surface thereof to permit the semiochemical volatiles to escape the device. The device may include means for closing the opening, such as when the device is not in use, and, more preferably, the size of the opening can be made adjustable to allow the user of the device control over whether to emit more or less of the volatiles, including complete shut off. The release device can vary in its shape or size to accommodate short periods of efficacy or long periods of efficacy. Devices can come in sizes made to last days or weeks by altering the amount of semiochemicals that are loaded into the absorbent material. What follows are more specific examples of suitable release devices for releasing semiochemicals when in combination with antioxidants and/or insect-inactive oils. However, it is to be understood that other release devices, including porous materials, may be used.

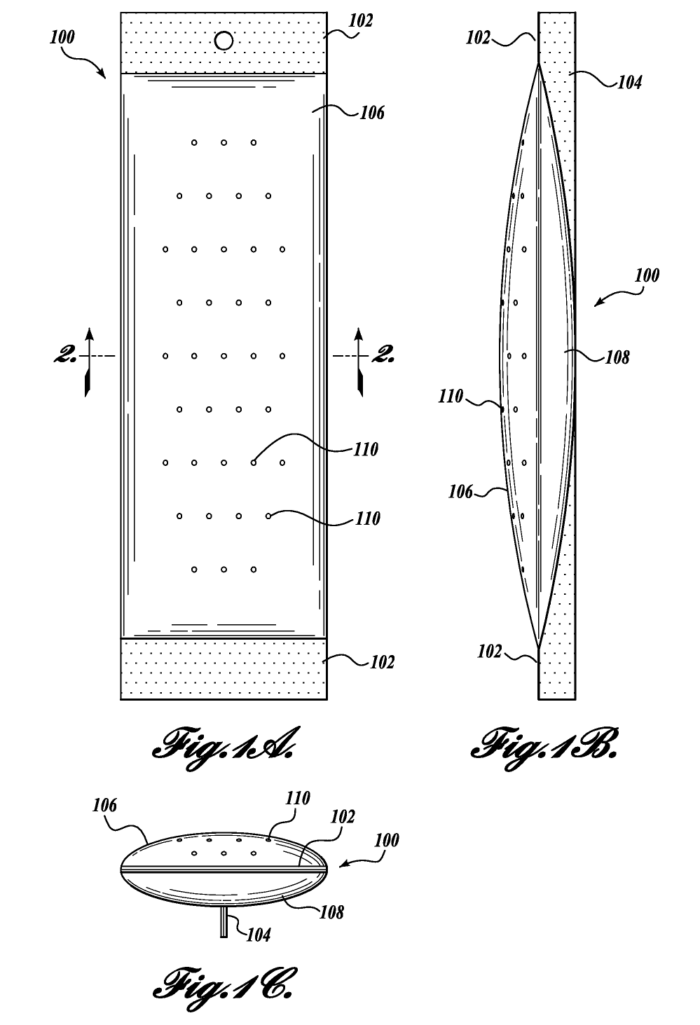

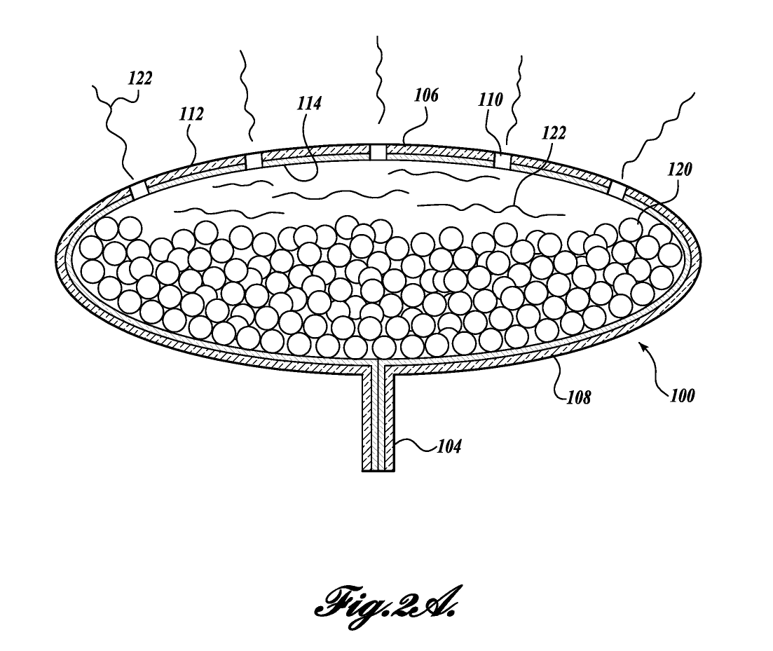

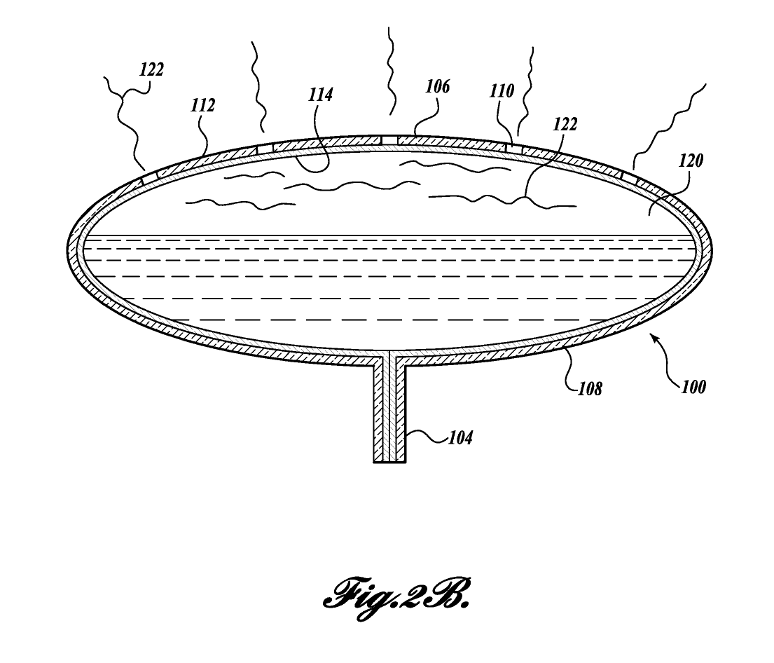

FIGS. 1A, 1B, and 1C illustrate front, side, and end views, respectively, of a sachet or stick pack 100. The stick pack 100 is a generally tubular structure formed from a sheet of material, preferably a polymeric sheet comprising multiple layers or laminae. The end portions 102 are sealed transversely, and a longitudinal sealed portion 104 closes the tubular structure, such that a volume is defined between the ends 102.

As discussed below, the properties and configuration of the multiple layers for stick packs 100 cooperatively restrict and control the release rate of volatiles from the semiochemicals that are packaged in the stick pack 100. In particular, the designer may select the materials and certain characteristics of the layers used for the sheet of material to achieve a desired volatile release rate. For example, the layer material properties (e.g., the porosity of the material to the selected semiochemical volatiles), the thickness of the layers, the characteristics of optional apertures (e.g., number, density, size, depth, and shape).

In the embodiment of FIGS. 1A-1C, a front panel 106 of the stick pack 100 optionally includes a pattern of micro-perforations 110 that are sized and configured to achieve a desired release rate of volatiles, as discussed below. In the current embodiment, a back panel 108 portion of the stick pack 100 does not include any micro-perforations. However, it is contemplated that in some applications it will be desirable that the back panel 108 also include micro-perforations 110. In some applications, the stick pack may be formed from a suitably permeable or porous material, wherein the permeability is sufficient to achieve a desired volatile release rate without the use of micro-perforations.

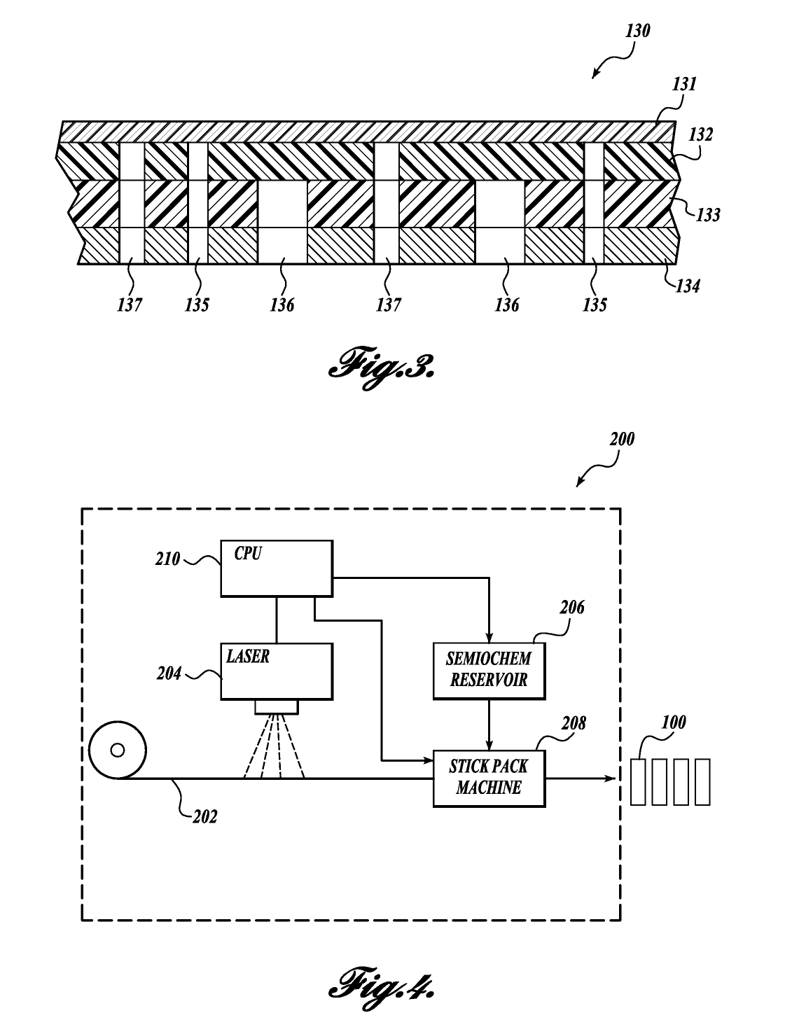

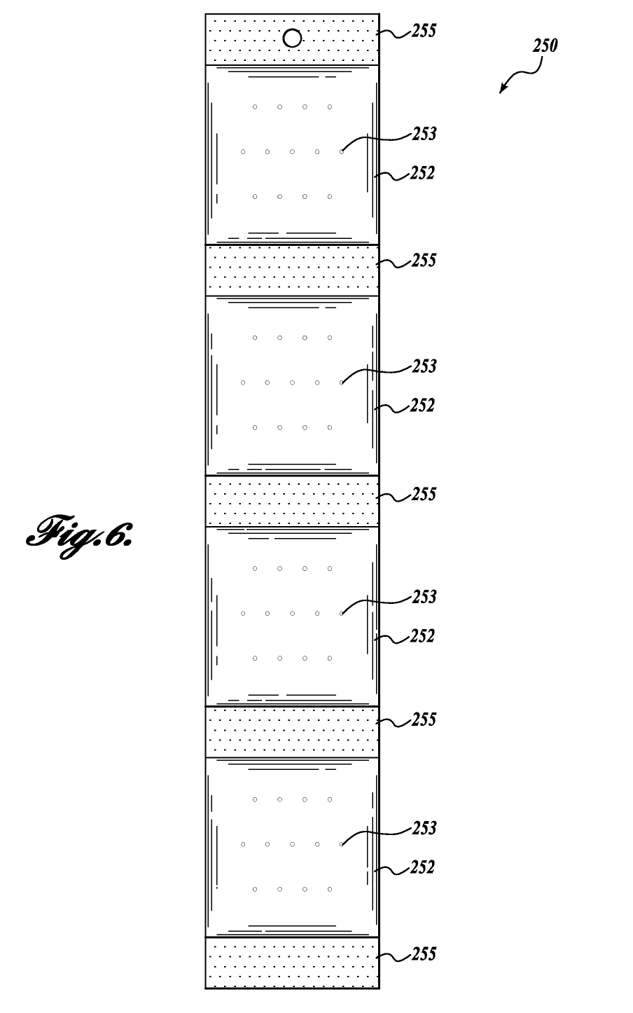

FIG. 2A illustrates a cross section of the stick pack 100 with the semiochemical composition 120 in the stick pack 100 illustrated generically. In this exemplary embodiment, the innermost layer 114 comprises a material having a relatively low density that is suitable for heat welding to form effective seals. The innermost layer 114 may also be selected for its permeability to the semiochemical volatiles 122. The outermost layer 112 is bonded or otherwise adhered to the innermost layer 114 and is formed of a relatively higher density material selected for its barrier functionality, mechanical strength, dimensional stability, and suitability for manipulation in a high speed stick pack machine (see, FIG. 4). The semiochemical composition 120 comprises one or more semiochemicals, and other components that may be desired, for example, to stabilize or otherwise affect the chemical or mechanical properties of the composition 120.

In FIG. 2A, the semiochemical composition 120 is illustrated in an idealized bead, powder, or particulate form having a characteristic size or dimension (e.g., diameter). Preferably, the micro-perforations 110 are sized to prevent the loss of the particulates therethrough. It is also contemplated that the semiochemical composition 120 may alternatively be in liquid form, incorporated into a gel, paste, or solid matrix, or absorbed into a porous medium such as a sponge or paper, for example. In liquid form, the semiochemical composition may be of relatively low viscosity, or a very viscous or viscoelastic material. The selected semiochemical volatilizes at the environmental conditions contemplated for its intended use. The quantity of semiochemical composition 120 may be such that the volume enclosed by the stick pack 100 is only partially filled by the composition 120. The remaining volume in the stick pack 100 may be partially or substantially filled with semiochemical vapors or volatiles 122. The volatiles 122 escape or are gradually released through the micro-perforations 110, and/or through any permeable layer defined by the stick pack 100.

In FIG. 2B, the semiochemical composition 120 is illustrated in an idealized liquid form. If the semiochemical composition 120 is in liquid form it is contemplated that the micro-perforations 110 will extend only through the outer layers 112, and the non-perforated inner layer 114 will therefore prevent any leakage of liquid semiochemical composition 120 therethrough. The inner layer 114, of course, is selected to permit a gradual release of semiochemical volatiles.

The rate of release of the volatiles 122 will depend in part on the characteristics of the micro-perforations 110. For example, the rate of release may depend on micro-perforation parameters such as (1) the number of perforations; (2) the size or distribution of sizes of the perforations; (3) the spacing and pattern of the perforations; (4) the shape of the perforations (e.g., elongate, star-shaped, circular); (5) the depth of the perforations (e.g., extending partially through the substrate); and (6) any blockage of the perforations. The designer and/or the user, therefore, have a number of parameters that may be used to control the rate of release of volatiles 122.

For example, the designer may select the size and number of micro-perforations 110 to accommodate a particular semiochemical or combination of semiochemicals 120 to achieve a desired release rate. A composition 120 having a semiochemical with a low volatility may require more and larger perforations than one with a semiochemical that is highly volatile. In another example, different configurations of micro-perforations 110 may be available, depending on the anticipated environmental conditions (e.g., temperature, humidity) for the expected use of the semiochemicals composition 120. For example, one configuration of micro-perforations in a semiochemical stick pack 100 may be suitable when lower temperatures are expected, and a different configuration may be suitable at higher temperatures. A family of semiochemical stick packs 100 may be made available to users, who will then select the particular stick pack 100 that suits their application. Optionally, a blocking element (not shown), for example, a strip of adhesive, a sleeve, or the like, may be provided to selectively block some portion of the micro-perforations 110, to selectively adjust the rate of release of volatiles 122, for example, to adjust for environmental conditions or to accommodate particular situations.

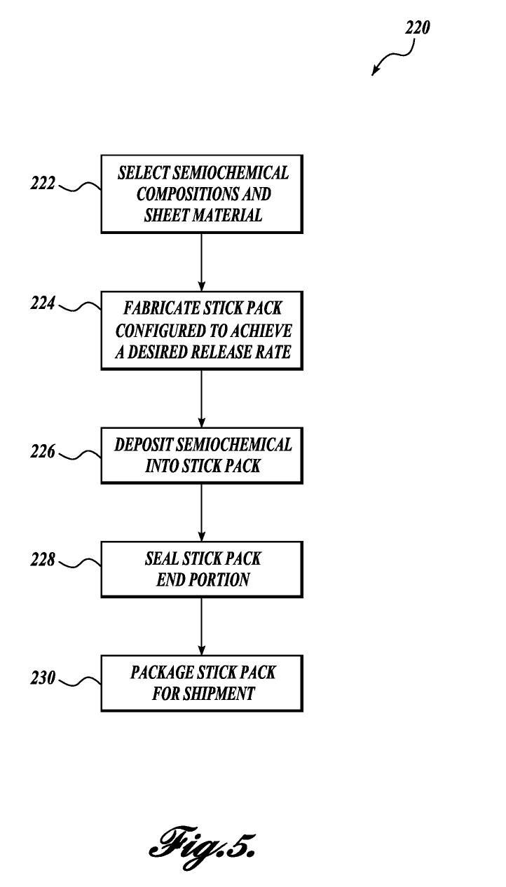

FIG. 3 illustrates an exemplary fragmentary cross section of a sheet 130 that may be used to form the stick pack 100. The sheet 130 includes one or more polymeric laminae, and may additionally include paper or foil laminae (barrier layer), for example. In this exemplary embodiment, the sheet 130 comprises four laminae 131, 132, 133, 134. An exemplary total thickness of the sheet 130 is in the range of 5.0 to 400.0 microns. In a current embodiment, the total thickness is between about 30.0 microns and 300.0 microns. The multiple laminae 131, 132, 133, 134 may be provided to produce a desired release rate of volatiles 122, and to achieve desired mechanical and manufacturability properties. For example, the material for the innermost lamina 131 may be selected, in part, for its ability to produce good and consistent longitudinal and end seals for the stick pack 100.

The material for one or more of the laminae 131, 132, 133, 134 may also be selected based on the permeability of the material to the semiochemical volatiles, providing an additional parameter to control the release rate of particular volatiles 122.

In FIG. 3, the micro-perforations have varying diameters and varying depths of penetration through the sheet 130. For example, micro-perforations 135 are relatively small in diameter and extend through the outer lamina 134 and all of the way to the inner lamina 131. If a solid semiochemical is to be used, for example, the micro-perforations 135 may alternatively extend through the inner lamina 131. Therefore, molecules of suitable size may escape from the stick pack 100 through the apertures 135. Micro-perforations 136, although relatively large in diameter, only extend through the two outermost laminae 133, 134. Therefore, only molecules that are permeable to the innermost laminae 131, 132 will readily escape through these micro-perforations 136. Micro-perforations 137 are of intermediate diameter, and extend through the three outermost laminae 132, 133, 134 in this exemplary embodiment.

Therefore, it will be appreciated that a stick pack 100 may be designed to contain a plurality of different semiochemicals in a mixture or agglomeration, and to provide different release rates for each of the different semiochemicals.

FIG. 4 illustrates a system 200 for producing a stick pack 100 containing one or more semiochemicals. The system 200 in this embodiment takes a roll of sheet material 202 and selectively directs a laser system 204 to produce a desired pattern of micro-perforations in or through the sheet material 202. Different commercial laser systems are suitable. For example, it is known in the packing industry to use CO₂ lasers, such as “sealed off” coherent CO₂ lasers. Such lasers are suitable for use to process paper, plastic film, and other flexible materials. By some accounts, the sealed off coherent CO₂ laser has become a tool of choice to process packaging materials due to its reliability, low cost, compact footprint, and high quality with respect to laser power and beam characteristics.

A reservoir 206 of the desired semiochemical composition provides product to a stick pack machine 208 that receives the sheet material 202 and forms the final stick pack 100 of semiochemical composition 120. The operation is controlled with a computer or stand-alone central processing unit (CPU) controller 210 that may be separate or integrated into the stick pack machine 208. The controller 210 is programmable to accommodate different sheet material 202 and semiochemicals 120, such that the system 200 may be operated to produce any number of different products.

A simplified flow chart 220 of a method in accordance with the present invention is shown in FIG. 5. The user first selects 222 one or more semiochemicals and sheet material for a particular application. The semiochemicals are selected with reference to the target insect. The selection of semiochemical(s) will include selection of the particular form and composition of the semiochemical, including any matrix material that may be useful for stabilizing or controlling the volatilization of the semiochemical. It may also be desirable to include semiochemicals that repel non-target insects. The composition may also include components to confer particular aesthetic aspects to the composition, such as color or scent. A composite sheet material for the stick pack package is also selected. The selection of the sheet material 202 may require consideration of the particular semiochemical composition selected. For example, the innermost lamina of the sheet material must be compatible with the semiochemical. One or more of the laminae may be selected for their permeability with respect to one or more of the semiochemicals.

The packaging for the stick pack 100 is fabricated 224, configured for the desired release rate of the volatiles, for example, with micro-perforations and/or selected permeability properties. The selected semiochemical(s) are deposited into the packaging or onto the sheet prior to sealing the package 226. The stick pack ends and longitudinal seam are sealed 228. The stick pack 100 may then be sealed in an outer package 230, for example, a foil pack or a plastic package, which is suitable for shipping and display. The sealed outer package inhibits the release of the volatiles prior to use. As an alternative or in addition, it is contemplated that a removable adhesive strip (not shown) may be placed over the micro-perforations and removed prior to use.

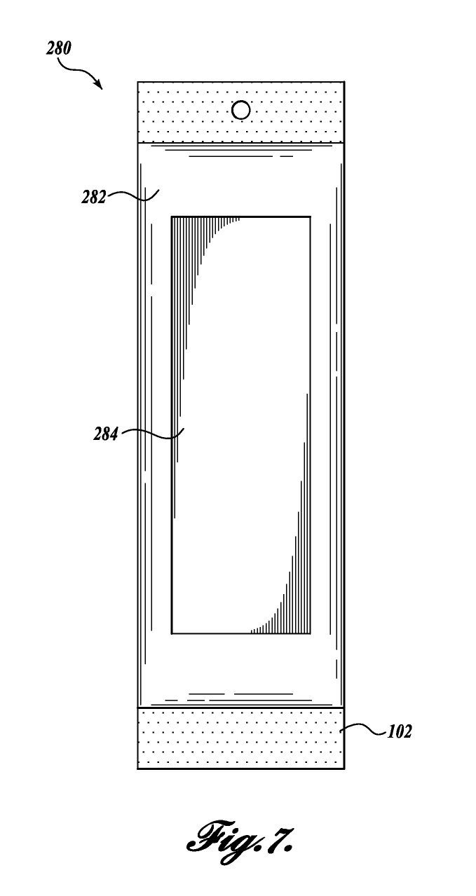

Although the above described stick pack 100 is formed with a single compartment for the semiochemical composition 120, it is contemplated that the stick pack may be formed with multiple compartments. FIG. 6 illustrates an exemplary multi-compartment stick pack 250. In this embodiment, four separate compartments 252 are defined in the stick pack 250, each separate compartment delineated by sealed ends 255. Although four compartments are shown, more or fewer compartments are also clearly contemplated. The individual compartments may all be of similar or identical physical characteristics, e.g., micro-perforation 253 size, pattern, and depth. For example, separate adhesive strips (not shown) may be applied over the micro-perforations 253 in each compartment 252, such that the compartments 252 may be individually opened for releasing volatiles. This gives a user the option to open multiple compartments 252 initially to increase the rate of release of semiochemicals, or to open each compartment 252 only after the previous compartment semiochemical has been exhausted or lost its effectiveness.

Alternatively, the compartments 252 may be configured differently, for example, to accommodate different semiochemical compositions 120. The multi-compartment stick pack 250 may therefore be readily designed to accommodate different semiochemicals, with the micro-perforations in each compartment 252 tailored to produce a desired rate of release of volatiles for each semiochemical. As discussed above, a punched hole may be included for hanging or otherwise attaching the stick pack 250 to a device.

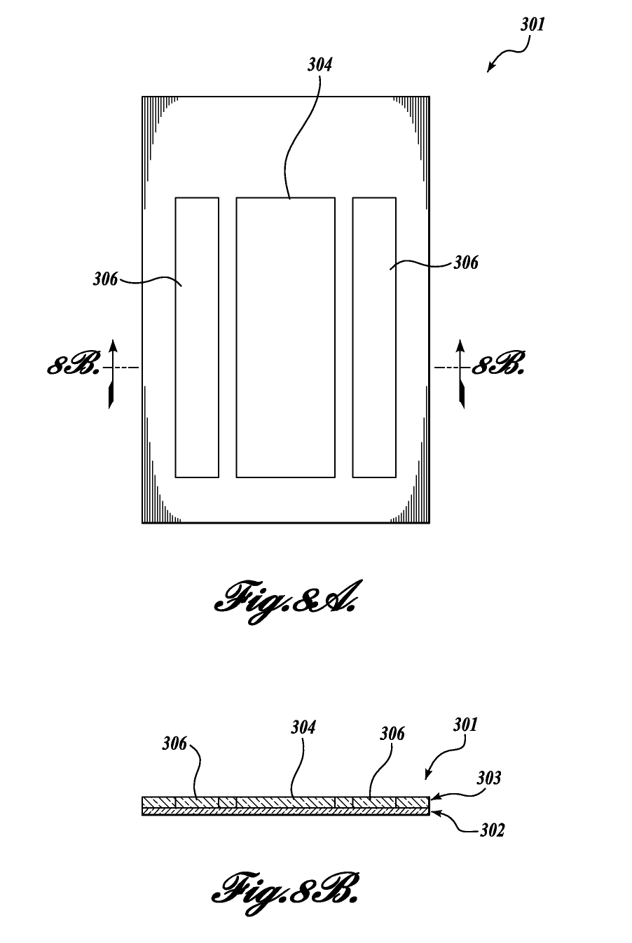

Another exemplary embodiment of a semiochemical stick pack 280 in accordance with the present invention is illustrated in FIG. 7. The stick pack 280 sachet is formed from a sheet material having at least an outermost lamina 282 as a barrier layer and an innermost lamina 284 as a sealing and releasing layer. This embodiment is similar to the stick pack 100 described above, except that rather than (or in addition to) a plurality of micro-perforations, windows are formed in the outermost lamina 282, defining an opening or “window” in the sachet that exposes the innermost lamina 284. The innermost lamina 284 may be permeable to the semiochemical volatiles to permit a gradual release rate and/or may include micro-perforations (not shown) to further control the release rate. The innermost lamina 284 is therefore exposed for release of volatiles. A packaging or other external barrier (not shown) to prevent or mitigate release of the semiochemical before deployment of the stick pack 280 storage before use could be provided. The packaging and stick pack are configured to maintain the integrity of the semiochemical contents over time, e.g., during shipment and storage, such that the semiochemical product will produce the desired release rate and retain its efficacy when the stick pack is deployed.

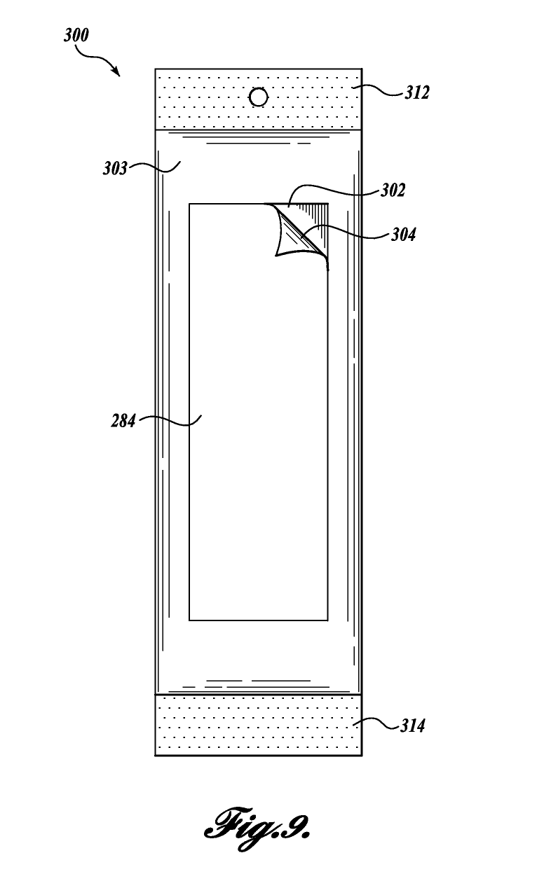

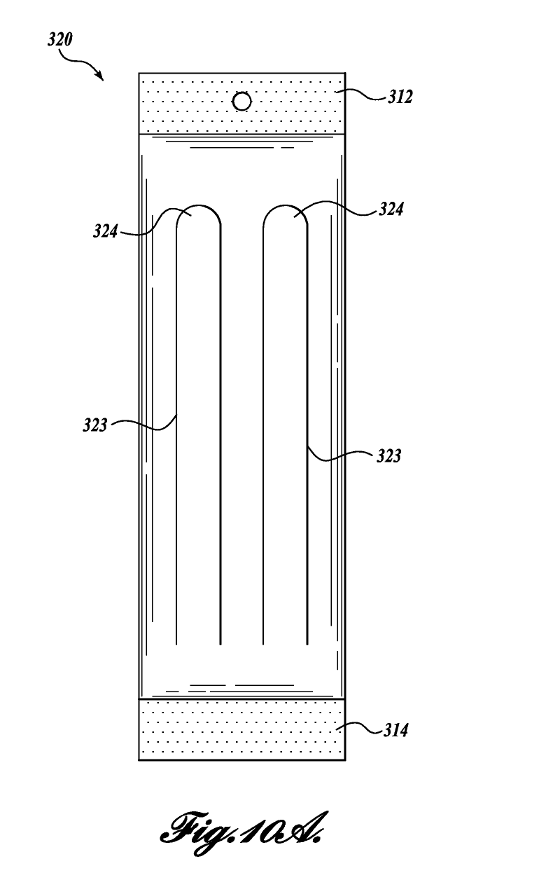

Another exemplary embodiment of a semiochemical stick pack 300 is illustrated in FIGS. 8A, 8B, and 9. FIG. 8A is a plan view of a portion of a sheet of material 301 for producing a single stick pack 300. It will be appreciated that the sheet of material would typically be configured on a continuous roll (not shown), and may include templates or room for multiple stick packs 300 across the width of the roll. FIG. 8B is a cross-sectional view of the unit template shown in FIG. 8A, with the depth dimension exaggerated for clarity.

In this embodiment, the inner layer 302 shown on the bottom in FIG. 8B is configured to define the inner lamina of the stick pack 300, and is adhered to an outermost layer 303. The outermost layer 303 includes one or more peel-away portions 304, 306 that are configured to be removed just prior to use, to open “windows” exposing a portion of the inner layer 302. The inner layer 302 may comprises a plurality of laminae, perhaps including micro-perforations as shown in FIG. 3, or may be a single layer without micro-perforations, and having a permeability to the semiochemical to provide the desired release rate.

It is contemplated that the peel-away portions 304, 306 may be produced using different methods, as are known in the art. In an exemplary method the peel-away portions 304, 306 are created or defined by leaving a selected window portion of the inner layer un-laminated during the sheet-making process, and laser scoring or cutting the outer layer 303, without cutting the inner layer 302. The peal-away operation may be carried out as part of the film-making process, i.e., before the stick pack is formed, or may be left for the end-user to perform, for example immediately before use.

FIG. 9 shows a front view of the stick pack 300, fully assembled and therefore containing the desired semiochemical. End seals 312, 314 close the stick pack 300 at the top and bottom ends, and a longitudinal seal 314 closes the lateral edges to define the tube structure. The first peel-away portion 304 is shown partially removed to expose a portion of the inner layer 302.

This packaging arrangement provides the end-user with great control and flexibility in controlling the release rate of the semiochemical contained therein, by allowing the end-user to determine how much of the peel-away portion 304 to peal down, and similarly how much of the options back side peal-away portions 306. For simplicity in manufacturing, in a current embodiment the peal-away portions are formed only on the front side of the stick pack.

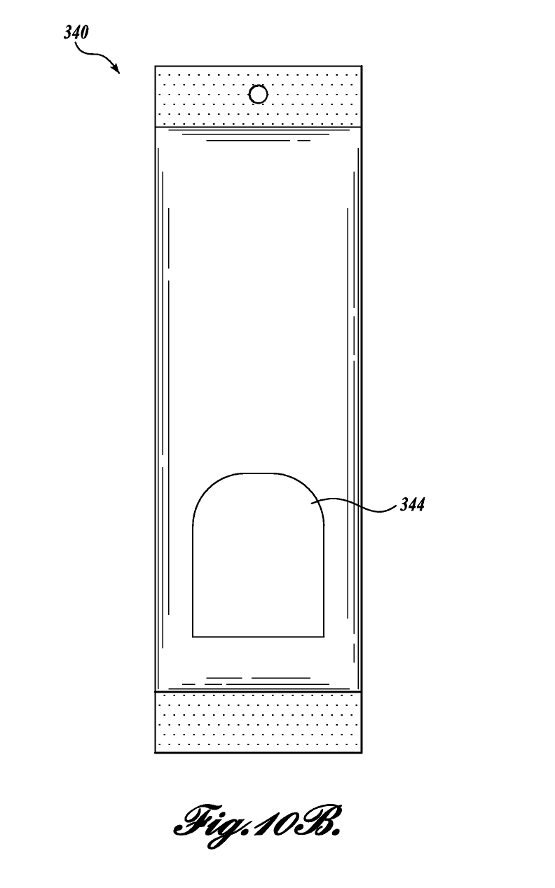

FIGS. 10A and 10B illustrate other embodiments of stick packs 320 and 340, respectively. The stick pack 320 includes two peal-away portions 324 defined by cuts or score lines 323. The score lines 323 are not closed, and therefore the peal-away portions 324 will generally remain attached to the stick pack 320. The multiple peal-away portions 324 allow an end-user to control the rate of release of volatiles from the stick pack 320 by pealing one or both of the peal-away portions 324 and/or by electing how far to pull the peal-away portion(s) 324 down the stick pack 320. Of course, more than two peal-away portions may used. In the embodiment in FIG. 10B, the stick pack 340 has a peal-away portion 344 that is much shorter than the length of the stick pack 340. Thus, for example, the user may more precisely control the location that volatiles are released from the stick pack 340.

The stick packs in accordance with the present invention may alternatively be used to release a very large amount of insect pheromone in the field, for example to disrupt the normal mating behavior of target insects (a pest control approach called “mating disruption”.

The stick packs in accordance with the present invention provide a mechanism for very precisely controlling the release rate of semiochemicals contained in the stick pack. In exemplary uses, the stick packs may be used in insect traps to lure the target insect into the trap with an attractant.

Alternatively, stick packs containing repellant semiochemicals may be distributed about a particular perimeter to drive a target species away from a region, and/or to discourage the target insect from entering the region. For example, the stick packs may be placed around the points of entry into a building, or around a tent or other portable shelter.

While the inclusion of semiochemicals with antioxidants and/or insect-inactive oils in the above-mentioned release devices may be the preferred method of dispensing some semiochemicals that are prone to degradation by oxygen, and ultraviolet light, some relatively heavy semiochemicals combined with antioxidants, and/or insect-inactive oils may also be dispensed by application onto various porous materials for direct maximum release.

Many porous materials are known for a wide range of applications in many diverse fields. Various porous plastics (polyethylene, polypropylene, EVA, Teflon etc.) have been widely used as filters, and other industrial functions. Their high surface areas are certainly good for absorption and holding, however, some low density and high porosity porous plastics might have just enough surfaces for holding or retaining heavy insect pheromones or attractants, but have bigger exposure area to air for improving the release rates of some heavy and stable insect pheromone compounds. The shape and size of pores and porosity can be easily varied to achieve certain surface areas for absorption and desorption (release), such as sheets, membranes and blocks. Polyfibers, including materials such as felts or sheets made of natural or synthetic fibers (polyester) could also provide similar surface areas and properties as the porous plastics. Plastic (polymer) foams, including various types of plastic foams, have been used for sponges and like products for absorption and for insulation (buildings, car seats, bedding etc.). However, some open-cell plastic foams can also be used for dispensing the heavy insect pheromone (attractants) or some repellents with a high level of active release rate thresholds for repellency. Other porous materials might include natural fibers, such as cellulose and glass fibers (fiberglass), and/or synthetic fibers, and any combination.

The goals of using semiochemicals in insect management are typically to monitor populations, and/or to alter insect behavior, for example to reduce target pest insect populations. Semiochemicals generally have the benefits of being highly targeted, relatively nontoxic, nonpersistent and environmentally safe, and difficult for insects to develop resistance against.

Accordingly, in view of the description herein, a method for controlling insect behavior is provided. The method includes placing into a release device configured to achieve a desired rate of release of semiochemical volatiles, a composition comprising an antioxidant and/or an insect-inactive oil; and a semiochemical; releasing semiochemical volatiles into an area, wherein the release rate of the semiochemical volatiles is controlled through the device, or the presence of the antioxidant or insect-inactive oil in the composition; and controlling the behavior of an insect within the area with the semiochemical volatiles.

The semiochemical may be a pheromone, an allomone, a kairomone, or a synomone.

The insect-inactive oil may be derived from a plant.

The insect-inactive oil may be a liquid.

The insect-inactive oil may be a vegetable oil.

The insect-inactive oil may be a nut oil.

The composition may include more than one semiochemical.

The composition may include more than one oil.

The composition may include more than one antioxidant.

The antioxidant may be α-tocopherol, propyl gallate, tertiary butylhydroquinone, butylated hydroxytoluene, or butylated hydroxyanisole.

The semiochemical may be released through one or more apertures in the release device.

The device may include a polymeric sheet comprising a plurality of laminae. An innermost lamina of the plurality of laminae may be semi-permeable such that the semiochemical in a volatilized state can pass through the innermost lamina.

The polymeric sheet may include an innermost lamina that is permeable to the semiochemical vapors and an outer lamina that is configured to peal away from the inner lamina.

The composition may be a liquid.

The use of the term “or” in the claims is used to mean “or” unless explicitly indicated to refer to alternatives only or the alternatives are mutually exclusive.

Throughout this application, the term “about” is used to indicate that a value includes the standard deviation of error for the device or method being employed to determine the value. In any embodiment discussed in the context of a numerical value used in conjunction with the term “about,” it is specifically contemplated that the term about can be omitted.

Following long-standing patent law, the words “a” and “an,” when used in conjunction with the word “comprising” in the claims or specification, denotes one or more, unless specifically noted.

While several embodiments have been illustrated and described, it will be appreciated that various changes can be made therein without departing from the spirit and scope of the invention.

The embodiments of the invention in which an exclusive property or privilege is claimed are defined as follows:

1. A method for controlling insect behavior, comprising:
placing into a release device configured to achieve a desired rate of release of semiochemical volatiles, a composition comprising an antioxidant and/or an insect-inactive oil; and a semiochemical;
releasing semiochemical volatiles into an area, wherein the release rate of the semiochemical volatiles is controlled through the device, or the presence of the antioxidant or insect-inactive oil in the composition; and
controlling the behavior of an insect within the area with the semiochemical volatiles.

2. The method of claim 1, wherein the semiochemical is at least one of a pheromone, an allomone, a kairomone, or a synomone.

3. The method of claim 1, wherein the semiochemical is selected from the group consisting of methyl(E,E,Z)-2,4,6-decatrienoate, methyl(E,Z)-2,4-dodecadienoate, (E)-4,8-dimethyl-1,3,7-nonatriene, (Z)-4,8-dimethyl-1,3,7-nonatriene, 4,8,12-trimethyl-1,3E,7E,11-tridecatetraene, any isomer or analog thereof, or any other semiochemicals that are known to easily oxide, isomerize, degrade or polymerize, and any combination thereof.

4. The method of claim 1, wherein the insect-inactive oil is derived from a plant.

5. The method of claim 1, wherein the insect-inactive oil is a vegetable oil.

6. The method of claim 1, wherein the insect-inactive oil is a nut oil.

7. The method of claim 1, wherein the composition comprises more than one semiochemical.

8. The method of claim 1, wherein the composition comprises more than one oil.

9. The method of claim 1, wherein the composition comprises more than one antioxidant.

10. The method of claim 1, wherein the antioxidant is at least one of α-tocopherol, propyl gallate, tertiary butylhydroquinone, butylated hydroxytoluene, and butylated hydroxyanisole.

11. The method of claim 1, wherein the semiochemical is released through one or more apertures in the release device.

12. The method of claim 1, wherein the device comprises a polymeric sheet comprising a plurality of laminae.

13. The method of claim 12, wherein an innermost lamina of the plurality of laminae is semi-permeable such that the semiochemical in a volatilized state can pass through the innermost lamina.

14. The method of claim 12, wherein the polymeric sheet further comprises an innermost lamina that is permeable to the semiochemical vapors and an outer lamina that is configured to peal away from the inner lamina.

15. The method of claim 1, wherein the composition is a liquid.

16. The method of claim 1, wherein the oil is a liquid.
